(19) United States
(12) Patent Application Publication
(10) Pub. No.: US 2007/0058321 A1
(43) Pub. Date: Mar. 15, 2007

(54) Electromagnetically driven valve and control method thereof

(76) Inventor: Masahiko Asano, Toyota-shi (JP)

Correspondence Address: KENYON & KENYON LLP, 1500 K STREET N.W., SUITE 700, WASHINGTON, DC, 20005, US

(21) Appl. No.: 11/492,973

(22) Filed: Jul. 26, 2006

(30) Foreign Application Priority Data
Sep. 9, 2005 (JP) 2005-262331

(51) Int. Cl. H01H 47/00

(52) U.S. Cl. 361/160

(57) ABSTRACT

An electromagnetically driven valve includes: a valve which has a valve shaft and moves reciprocally in the direction in which the valve shaft extends; a disc which is a magnetic member that moves in conjunction with the valve; an electromagnet which has a coil and attracts the disc and keeps it in a predetermined position; a torsion bar which is an elastic member that applies a force separating the magnetic member from the electromagnet; and an ECU which controls the magnetic force of the electromagnet. When separating the disc from the electromagnet by reducing the magnetic force of the electromagnet, the ECU controls a electric current supplied to the coil such that there is a period of time during which the electric current that is between a predetermined holding electric current and zero is supplied while the electric current is being reduced from the predetermined holding electric current to zero.

### INCORPORATION BY REFERENCE

The disclosure of Japanese Patent Application No. 2005-262331 filed on Sep. 9, 2005, including the specification, drawings and abstract is incorporated herein by reference in its entirety.

### BACKGROUND OF THE INVENTION

1. Field of the Invention

The invention relates to an electromagnetically driven valve. More specifically, the invention relates to an electromagnetically driven valve used as an intake valve or an exhaust valve in an internal combustion engine, and a control method of that electromagnetically driven valve.

2. Description of the Related Art

Japanese Patent Application Publication No. JP-A-11-101110, for example, discloses one related electromagnetically driven valve for an internal combustion engine which is a single coil type electromagnetically driven valve in which there is a movable plate provided on both sides of an electromagnet and a valve is integrated with those movable plates. In this example, the gaps between the electromagnet and the movable plates on both sides thereof are such that one is narrower than the other even when the valve is in the middle position, as it is initially when electric current is not running through the coil. When electric current flows through the coil, the movable plate that is closer to the electromagnet (i.e., the movable plate having the narrower gap) is attracted to the electromagnet. When the electric current is temporarily interrupted, the valve is pushed back to the opposite side (e.g., from fully closed to fully open) by a valve spring and moves past the middle position by inertia force. Then when electric current flows through the coil again, the movable plate is kept on the opposite side by electromagnetic force.

FIG. 5 is a view showing the current value when the electromagnetically driven valve is operated from a closed state to an open state by reducing a holding electric current.

Referring to FIG. 5, the holding electric current for keeping the electromagnetically driven valve closed is supplied to the coil from time t10 to time t11. When the holding electric current is interrupted at time t11, the valve starts to open by the spring force of the spring. Then between time t13 and time t15, the attracting electric current is increased such that the electromagnet on the valve-open side attracts the movable plate. At time t16 and thereafter the holding electric current for maintaining that state of attraction is supplied to the coil.

When the holding electric current for keeping the valve closed is momentarily reduced all the way to zero at time t11, however, a back electromotive electric current or eddy electric current is generated by the energy stored in the reactor of the coil. As a result, a force which inhibits movement of the movable plate by the spring acts in the direction to open the valve from a valve-closed state, thus preventing smooth operation of the valve. This also happens when the valve starts to move from the open position to the closed position.

That is, when the holding electric current that keeps the movable plate in the valve-closed (or valve-open) position is reduced to move the movable plate in a direction to open (or close) the valve and the holding electric current is momentarily reduced to zero ampere, the magnetic flux and inductance change drastically, producing a back electromotive electric current or eddy electric current in the coil. The electromagnetic force generated by these electric currents is a so-called brake electromagnetic force which is an electromagnetic force that inhibits movement of the movable plates, thus resulting in energy loss which in turn leads to increased power consumption and the like. This kind of problem tends to occur particularly at low voltages where the power loss effect due to an eddy electric current is larger.

### SUMMARY OF THE INVENTION

In view of the foregoing problems, this invention thus provides an electromagnetically driven valve having improved energy efficiency, and a control method of that electromagnetically driven valve.

Accordingly, one aspect of the invention relates to an electromagnetically driven valve which is provided with a valve which has a valve shaft and moves reciprocally in the direction in which the valve shaft extends; a magnetic member which moves in conjunction with the valve; a first electromagnet which has a first coil and attracts the magnetic member and keeps it in a predetermined position; a first elastic member which applies a force separating the magnetic member from the first electromagnet to the magnetic member; and a control unit which controls the magnetic force of the first electromagnet. When separating the magnetic member from the first electromagnet by reducing the magnetic force of the first electromagnet, the control unit controls electric current supplied to the first coil such that there is a period of time during which the electric current that is between a predetermined holding electric current and zero is supplied while the electric current supplied to the first coil is being reduced from the predetermined holding electric current to zero.

The magnetic member may be a oscillating member in which pivoting end thereof is oscillatably supported in a base member, and which has at the driving end an operating portion that reciprocally moves the valve shaft in the direction in which the valve shaft extends.

The control unit may uniformly reduce the electric current during the period of time during which the electric current that is between the predetermined holding electric current and zero is supplied.

The control unit may also repeatedly increase and decrease the electric current in pulses during the period of time during which the electric current that is between the predetermined holding electric current and zero is supplied.

The control unit may further control the electric current such that the electric current flowing to the first coil becomes a rectangular wave or a sine wave during the period of time during which the electric current is repeatedly increased and decreased in pulses.

The predetermined position may be a valve-closed position, and the electromagnetically driven valve may further include a second electromagnet which attracts the magnetic member and keeps it in the valve-open position; and a second elastic member which applies a force separating the magnetic member from the second electromagnet to the magnetic member by applying an elastic force to the valve shaft.

The control unit may control the electric current of the first coil such that the electric current that is between the predetermined holding electric current and zero continues to be supplied for a period of time even after the magnetic member starts to be displaced from the valve-closed position toward the valve-open position, until the electric current becomes zero.

The second electromagnet may include a second coil which is connected to the first coil, and equal electric current is supplied to the first and second coils.

The control unit may perform control to supply the electric current for attracting the magnetic member to the second electromagnet, to the first and second coils after the electric current flowing to the first and second coils has been reduced from the predetermined holding electric current to zero.

The control unit reduces the electric current supplied to the first coil during the period of time during which the electric current that is between the predetermined holding electric current and zero is supplied such that a back electromotive electric current or eddy electric current is not generated in the first coil after the electric current flowing to the first coil has been reduced from the predetermined holding electric current to zero.

A second aspect of the invention relates to a control method for an electromagnetically driven valve which attracts a magnetic member, which moves in conjunction with a valve that moves back and forth in the direction in which a valve shaft extends, to an electromagnet and keeping the magnetic member in a predetermined position by supplying a predetermined holding electric current to a coil of the electromagnet. This control method includes the step of separating the magnetic member from the electromagnet by reducing a magnetic force of the electromagnet by supplying electric current that is between the predetermined holding electric current and zero to the coil for a predetermined period of time while the electric current supplied to the coil is being reduced from the predetermined holding electric current to zero.

The first and second aspects of the invention make it possible to realize an electromagnetically driven valve with reduced power consumption.

### BRIEF DESCRIPTION OF THE DRAWINGS

The foregoing and further objects, features and advantages of the invention will become apparent from the following description of preferred embodiments with reference to the accompanying drawing, wherein like numerals are used to represent like elements and wherein:

FIG. 1 is a view schematically showing the structure of an electromagnetically driven valve according to an example embodiment of the invention;

FIG. 2 is a cross-sectional view taken along line II-II in FIG. 1;

FIG. 3 is a waveform chart showing a first example of a coil electric current according to the example embodiment of the invention;

FIG. 4 is a waveform chart showing a second example of a coil electric current according to the example embodiment of the invention; and

FIG. 5 is a view showing the current value when the electromagnetically driven valve is operated from a closed state to an open state by reducing the holding electric current.

### DETAILED DESCRIPTION OF THE PREFERRED EMBODIMENTS

Hereinafter, an example embodiment of the invention will be described in detail with reference to the accompanying drawings. Like or corresponding parts in the drawings will be denoted by like reference characters and descriptions thereof will not be repeated.

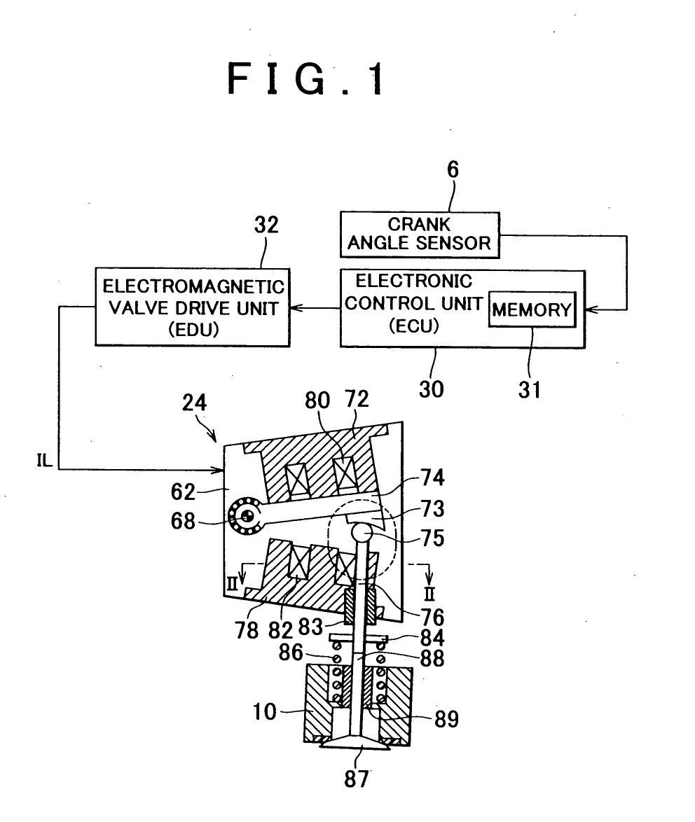

FIG. 1 is a view schematically showing the structure of an electromagnetically driven valve according to an example embodiment of the invention. An engine, i.e., an internal combustion engine, includes a cylinder block in which are formed a plurality of cylinders, a cylinder head, a piston which moves up and down in each cylinder, an electromagnetically driven intake valve provided in an intake port of each cylinder, and an electromagnetically driven exhaust valve provided in an exhaust port of each cylinder. The intake and exhaust valves are provided in sets of, for example, two each for each cylinder.

For simplicity, however, only one electromagnetically driven valve is representatively shown in FIG. 1. A crank angle sensor 6 which detects the engine speed is mounted to the cylinder block of the engine. Outputs from various sensors such as this crank angle sensor 6 are input to an electronic control unit (ECU) 30. This ECU 30 controls the injection timing and injection quantity of a fuel injection valve and the ignition timing of a spark plug, as well as instructs an electromagnetic drive unit (EDU) 32 as to the valve-opening timing of an electromagnetic actuator 24 that drives the intake valve or the exhaust valve.

The electromagnetically driven valve includes a valve 87 that has a valve shaft and moves back and forth in the direction in which the valve shaft extends, a disc 74 which is a magnetic member that moves in conjunction with the valve 87, a first electromagnet that has a first coil 80 and attracts the disc 74 and keeps it in a valve-closed position, a torsion bar 68 which is a first elastic member that applies a force separating the magnetic member from the first electromagnet to the magnetic member, and the ECU 30 that controls the magnetic force of the first electromagnet.

When separating the disc 74 from the first electromagnet by reducing the magnetic force of the first electromagnet, the ECU 30 controls the electric current flowing to the first coil such that there is a period during which a electric current that is between a predetermined holding electric current and zero is supplied while the electric current supplied to the first coil 80 is reduced to zero from the predetermined holding electric current. The disc 74 is a oscillating member in which pivoting end thereof is oscillatably supported in a housing 62, and which has at the driving end an operating portion that reciprocally moves the valve shaft 88 in the direction in which the valve shaft extends.

The electromagnetically driven valve further includes a second electromagnet which attracts the disc 74 and keeps it in a valve-open position, and a lower spring 86 which is a second elastic member that applies a force to separate the disc 74 from the second electromagnet to the magnetic member by applying elastic force to the valve shaft.

The electronic control unit (ECU) 30 includes memory 31 in which is stored, in the form of a map, an energizing pattern that corresponds to output from the crank angle sensor 6.

The valve 87 opens and closes an intake port or an exhaust port provided in a cylinder head 10 by lifting up and down. An intermediate stem 76 is provided on an upper portion of a valve shaft 88 which extends upward from the valve 87. A cam follower pin 75 is attached to the upper end of the intermediate stem 76. The valve 87 moves back and forth in the direction in which the valve shaft 88 extends.

A stroke ball bearing 89 is provided between the valve shaft 88 and the cylinder head 10 such that the valve shaft 88 is movably supported in the vertical direction. A flange portion 84 is provided on the lower end of the intermediate stem 76, and the lower spring 86 is arranged between this flange portion 84 and the cylinder head 10 on the circumference of the valve shaft 88.

The electromagnetic actuator 24 includes a valve-opening electromagnet and a valve-closing electromagnet fixed to the housing 26. The valve-opening electromagnet includes a valve-opening core 78 and a coil 82. Similarly, the valve-closing electromagnet includes a valve-closing core 72 and a coil 80. In this example embodiment, the coil 80 and the coil 82 have a single coil construction in which they are connected together and used in combination. Alternatively, however, the coils 80 and 82 do not have to have a single coil construction, and the electric current in each of the coils 80 and 82 may be controlled separately by the EDU 32.

These valve-opening and valve-closing electromagnets attract the disc 74 which is a oscillating member with pivoting end oscillatably supported in the housing 62.

The elastic force of the torsion bar 68, which is an upper spring that forms a pair with the lower spring 86, causes the disc 74 to apply a downward force, i.e., a force in the valve-opening direction, to the intermediate stem 76. A cam follower tip 73 is attached to the driving end of the disc 74. This cam follower tip 73 abuts against the cam follower pin 75 fixed to the upper end of the intermediate stem 76 and applies a downward force, i.e., a force in the valve-opening direction, to the intermediate stem 76.

In contrast, the lower spring 86 applies an upward force, i.e., a force in the valve-closing direction, to the intermediate stem 76 by pushing up on the flange portion 84.

The resultant force from the torsion bar 68 and the lower spring 86 generates a force in the valve-opening direction when the valve 87 is fully closed, and conversely, generates a force in the valve-closing direction when the valve 87 is fully open. Using the elastic force generated by the spring when the electromagnetic force attracting the disc 74 is weak due to the distance between the disc 74 and the electromagnet coil that is attracting the disc 74 being large, enables the electromagnet to be reduced in size.

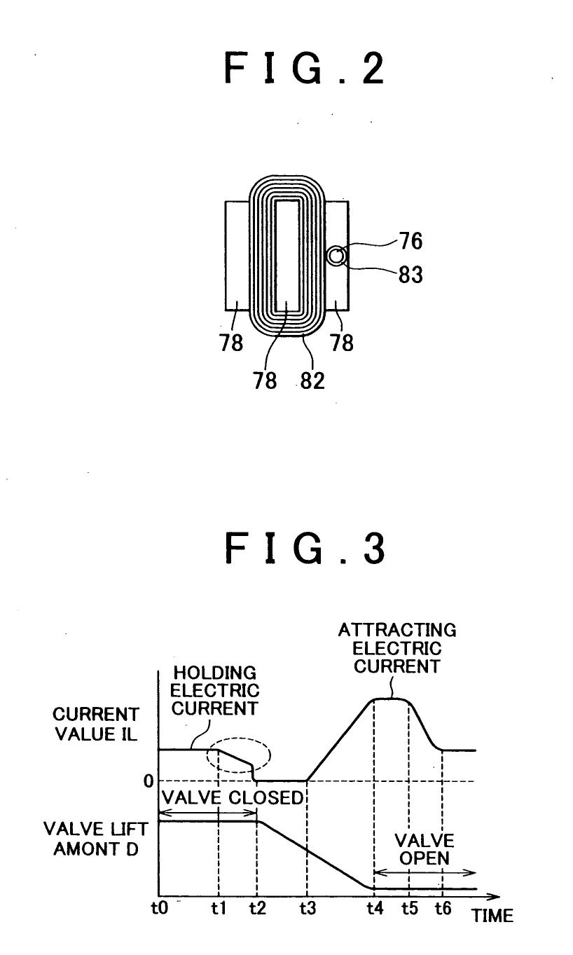

FIG. 2 is a cross-sectional view taken along line II-II in FIG. 1. Referring to FIG. 2, the coil 82 is wound around the valve-opening core 78. A hole which accommodates the intermediate stem 76 and the stroke ball bearing 83 is formed in a portion of the valve-opening core 78. If this hole is large, the area of the magnetic path of the valve-opening core 78 is reduced so the valve-opening core 78 must be made larger by a corresponding amount. Thus the size of the hole is restricted to a degree in order to reduce the size of the electromagnetically driven valve.

FIG. 3 is a waveform chart showing a first example of a coil electric current according to the example embodiment of the invention. Referring to FIGS. 1 and 3, the valve is closed between time t0 and time t2, and is open from time t4 on. From time t0 to time t1, a holding electric current is supplied to the coils 80 and 82. At this time, the disc 74 is closer to the coil 80 than it is to the coil 82. The closer the disc 74 is to the electromagnet the stronger the force acting on the disc 74 so the disc 74 is kept attracted to the coil 80 side.

From time t1 to time t2 is a period of gradual change in which an intermediate electric current that is between the holding electric current and zero is supplied. During this period of gradual change shown in FIG. 3, the electric current is gradually and uniformly reduced.

Then at time t2, a current value IL is reduced to zero and kept there until time t3. As a result, the elastic force of the torsion bar 68 causes the disc 74 to push the intermediate stem 76 down such that the lift amount D of the valve changes from one indicative of the valve-closed position to one indicative of the valve-open position.

Then when the attraction electric current is increased from time t3 to time t4, the disc 74 becomes attracted to the electromagnet on the coil 82 side. This attraction state is maintained between time t4 and time t5. Then from time t6, a holding electric current sufficient to maintain this attracted state is supplied.

As shown in FIG. 3, there is a period of gradual change between time t1 and time t2, in which the holding electric current is reduced gradually and uniformly while being reduced to zero. Accordingly, a back electromotive electric current or eddy electric current such as that illustrated in FIG. 5 is less apt to occur, which also reduces the brake force caused by the back electromotive electric current or eddy electric current, which inhibits movement of the valve.

Thus it is possible to reduce brake electromagnet force when the disc (armature) starts to move, and therefore achieve operation with reduced power consumption, increased output and at a low voltage.

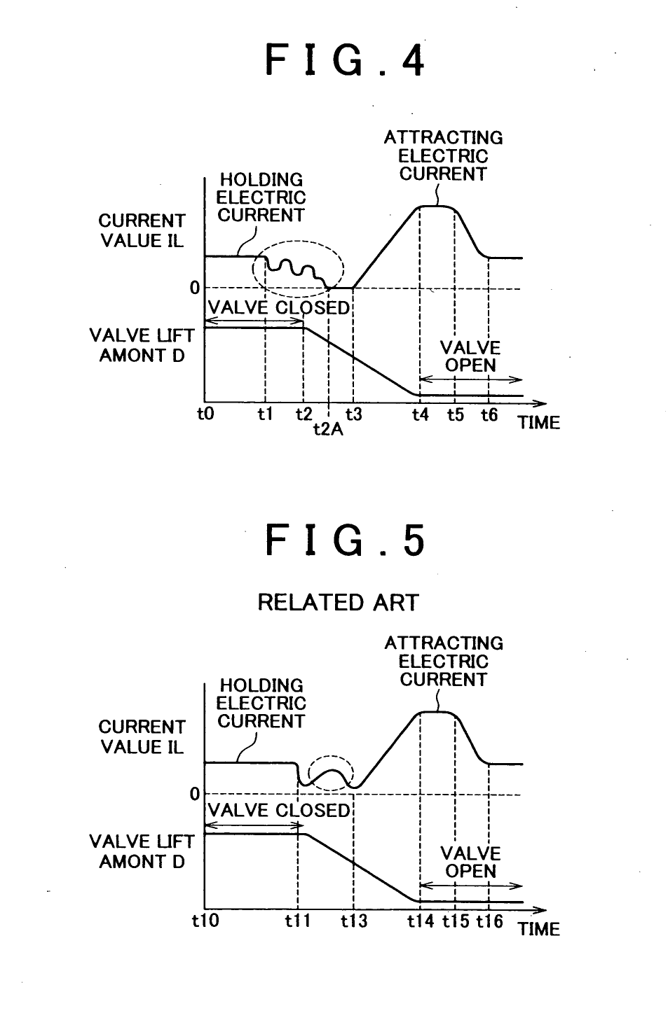

FIG. 4 is a waveform chart showing a second example of a coil electric current according to the example embodiment of the invention. The electric current waveform shown in FIG. 4 differs from the electric current waveform shown in FIG. 3 in that there is a period of time during which the electric current is repeatedly increased and decreased in pulses from time t1 to time t2A. Gradually reducing the electric current to zero while changing it in pulses in this way makes it possible to reduce the electric current while little by little canceling out the change in the magnetic flux that occurs when the holding electric current is interrupted. Thus, brake electromagnetic force can be reduced even further such that the valve is able to move smoothly and power consumption can be reduced.

When the electric current is repeatedly increased and decreased in pulses, those pulses do not have to be exact rectangular waveforms. Alternatively, they may be rounder waveforms that are closer to sine waves.

The example embodiments disclosed herein are in all respects merely examples and should in no way be construed as limiting. The scope of the invention is indicated not by the foregoing description but by the scope of the claims for patent, and is intended to include all modifications that are within the scope and meanings equivalent to the scope of the claims for patent.

What is claimed is:

1. An electromagnetically driven valve comprising:
a valve which has a valve shaft and moves reciprocally in the direction in which the valve shaft extends;
a magnetic member which moves in conjunction with the valve;
an first electromagnet which has a first coil and attracts the magnetic member and keeps the magnetic member in a predetermined position;
an first elastic member which applies a force separating the magnetic member from the first electromagnet to the magnetic member; and
a control unit which, when separating the magnetic member from the first electromagnet by reducing the magnetic force of the first electromagnet, controls electric current supplied to the first coil such that there is a period of time during which the electric current that is between a predetermined holding electric current and zero is supplied while the electric current supplied to the first coil is being reduced from the predetermined holding electric current to zero.

2. The electromagnetically driven valve according to claim 1, wherein the magnetic member is a oscillating member in which pivoting end thereof is oscillatably supported in a base member, and which has at the driving end an operating portion that reciprocally moves the valve shaft in the direction in which the valve shaft extends.

3. The electromagnetically driven valve according to claim 2, wherein the control unit uniformly reduces the electric current during the period of time during which the electric current that is between the predetermined holding electric current and zero is supplied.

4. The electromagnetically driven valve according to claim 2, wherein the control unit repeatedly increases and decreases the electric current in pulses during the period of time during which the electric current that is between the predetermined holding electric current and zero is supplied.

5. The electromagnetically driven valve according to claim 4, wherein the control unit controls the electric current such that the electric current flowing to the first coil becomes a rectangular wave or a sine wave during the period of time during which the electric current is repeatedly increased and decreased in pulses.

6. The electromagnetically driven valve according to claim 1, wherein the predetermined position is a valve-closed position, and the electromagnetically driven valve further comprises a second electromagnet which attracts the magnetic member and keeps the magnetic member in the valve-open position; and a second elastic member which applies a force separating the magnetic member from the second electromagnet to the magnetic member by applying an elastic force to the valve shaft.

7. The electromagnetically driven valve according to claim 6, wherein the control unit controls the electric current of the first coil such that the electric current that is between the predetermined holding electric current and zero continues to be supplied even after the magnetic member starts to be displaced from the valve-closed position toward the valve-open position.

8. The electromagnetically driven valve according to claim 6, wherein the second electromagnet includes a second coil which is connected to the first coil, and equal electric current is supplied to the first coil and the second coil.

9. The electromagnetically driven valve according to claim 8, wherein the control unit performs control to supply the electric current for attracting the magnetic member to the second electromagnet, to the first coil and the second coil after the electric current flowing to the first coil and the second coil has been reduced from the predetermined holding electric current to zero.

10. The electromagnetically driven valve according to claim 1, wherein the control unit reduces the electric current supplied to the first coil during the period of time during which the electric current that is between the predetermined holding electric current and zero is supplied such that a back electromotive electric current or eddy electric current is not generated in the first coil after the electric current flowing to the first coil has been reduced from the predetermined holding electric current to zero.

11. A control method for an electromagnetically driven valve, comprising:
attracting a magnetic member, which moves in conjunction with a valve which moves back and forth in the direction in which a valve shaft extends, to an electromagnet and keeping the magnetic member in a predetermined position by supplying a predetermined holding electric current to a coil of the electromagnet; and
separating the magnetic member from the electromagnet by reducing a magnetic force of the electromagnet by supplying a electric current that is between the predetermined holding electric current and zero to the coil for a predetermined period of time while the electric current supplied to the coil is being reduced from the predetermined holding electric current to zero.
